(19) United States
(12) Patent Application Publication
(10) Pub. No.: US 2003/0145511 A1
(43) Pub. Date: Aug. 7, 2003

(54) Bait tray with a breachable internal seal

(75) Inventors: Leslie E. Finn, Pleasanton, CA (US); Rebecca Fong, Dublin, CA (US)

Correspondence Address: CONNOLLY BOVE LODGE & HUTZ LLP, 1220 Market Street, P.O. Box 2207, Wilmington, DE, 19899, US

(73) Assignee: Aventis Environmental Science S.A., Lyon (FR)

(21) Appl. No.: 10/288,752

(22) Filed: Nov. 6, 2002

Related U.S. Application Data
(63) Continuation of application No. 09/661,632, filed on Sep. 13, 2000, now abandoned.

(51) Int. Cl. A01M 1/20; A01M 25/00

(52) U.S. Cl. 43/131

(57) ABSTRACT

An insect feeding station having a unitary base portion formed from a deformable material such as a plastic material, the base portion having a bait-toxicant in an inner compartment and having a breachable internal seal covering said compartment, ridges and walls, forming guiding and baffle means to guide insects from the periphery of the station to the inner compartment and to prevent probing of the poison from outside the station, and optionally, a partially or totally transparent cover and optionally having also a contrasting color under the poison to make removed bait toxicant easily detectable.

### BACKGROUND OF THE INVENTION

This invention relates to a device for destroying insects. It more particularly relates to an improved insect feeding station or bait tray whereby poison may be administered to insects without endangering children or domestic animals, and having means to guide insects to the poison. Said station or tray may be readily and inexpensively formed from deformable materials such as plastic, by well-known thermoforming, vacuum forming or injection molding methods. Said station or tray contains an interior seal or protective barrier over the poison or bait that allows activation by breaching the seal without removing the cover of the station.

Various types of devices have been known in the prior art for destroying insects. In some devices, the insects are trapped in the device after entering, either by mechanical construction, or by sticking to a gummy substance. In either instance, the device is soon full and useless. In devices, which contained a poison, it was easy to shake out loose poison, or probe through openings to reach the poison, thus making them a danger to children or small domestic animals. In the instance of using moisture-containing baits, such as gels, previous devices would not be satisfactory because they would allow the bait to evaporate moisture and become firm and unpalatable; or, in some instances absorb moisture and liquefy and run out of the bait station. In addition, prior devices are generally of a construction that the interior of the device is difficult to view so that it is not readily ascertainable whether insects are using the device or how much poison has been used.

U.S. Pat. No. 5,271,180 refers to an insect bait station utilizing a selective wavelength transparent cover as a means for inspecting the internal contents of the bait station.

U.S. Pat. No. 5,021,237 refers to a moist gel in water composition suitable for dispensing from a pressurized container. The gel formulation is preferred in many instances as a means for delivery of a toxicant when the gel is stable and presents sufficient bulk and moisture to satisfy the feeding insect.

U.S. Pat. No. 4,804,142 refers to a pest repellant device with a seal readily punctured to permit access to repellant composition. However, this seal is on the exterior of the device and once punctured, provides protection against access thereto.

U.S. Pat. No. 4,563,836 describes various insect feeding stations having a unitary base and a translucent cover. Bait and poison are placed in the central area of the base and ridges form guides and baffles as a means to guide insects from the periphery to the central area.

It is desirable to deliver the bait and toxicant in such a form and to remain in such form as to be readily available for ingestion by insects. Moisture-containing or gel-like compositions with high viscosity are highly desirable. The objective of this invention is to deliver such a product to the site where control is sought without loss of bait, moisture or other volatile components therefrom by evaporation or by mechanical means prior to activation or breaching of seal by end user.

It is, therefore, an object of this invention to provide an insect feeding station, which is not dangerous to children.

A further object is to provide an insect feeding station in which it is readily possible to detect the use of the poison and in which the bait is contained and protected until used.

Another object is to provide an insect feeding station, which is easily and inexpensively formed from deformable materials by known methods.

Another object is to provide means to guide insects toward the poison in an insect feeding station.

These and other objects of the invention will become apparent as the description thereof proceeds. The objects of this invention may be attained and the disadvantages of the prior art devices overcome by the use of the present invention.

### SUMMARY OF THE INVENTION

The invention has a base portion for carrying the poison and a cover. The base portion has outer case walls having a plurality of openings and has a poison located at the center of the case. The outer case may be of any configuration, e.g., round, square, or rectangular.

The base has inner guide and baffle walls leading from peripheral openings up to the bait and the walls are so positioned that a probe cannot contact the bait if thrust through any of the outer wall openings.

The base is formed as a unitary piece from a deformable material such as a plastic by known methods. One method for forming the base is from a flat sheet of plastic which is either thermoformed or vacuum formed over a suitably designed mold to form the ridges which act as guide and baffle walls, and the inner compartment or central poison/bait area. It is also possible to form the base by injection molding of a molten plastic into a suitably designed mold. The cover of the device is also formed in like manner as a unitary piece, which is then attached to the top of the device. The cover is permanently affixed to the base and optionally has at least a part, which is transparent so that the poison is visible through the cover.

The poison is preferably of the type known as bait, i.e., it is a mixture of slow acting poison and some food material attractive to insects, such as flour, molasses, peanut butter, oatmeal, carbohydrates such as fructose, glucose, maltose, or arabinose, yeast, starches such as corn starch, oils such as soybean oil, canola oil or peanut oil, proteinaceous material such as silkworm pupae, fish meal, bone meal, and dairy products such as cheese. The bait is preferably of a paste-like or gel-like consistency. Thus, insects are attracted to the device, eat the bait and leave the device to die elsewhere, depending on the action of the poison. The bait is contained in a depression or well in the center of the tray's inner compartment.

Within the bait station is provided an inner compartment for an exterminating composition for insects, preferably for ants or cockroaches, wherein the inner compartment having a depression or well is provided with a breachable sealing member. When the sealing member is breached, the bait is exposed and the bait station becomes activated and the composition is accessible to the insects without removing or opening the station. For example, said seal may be made of plastic material, paper stock, inert metallic foil or laminates thereof.

Thus, insects are attracted to the device or bait station, eat the bait and leave the device to die elsewhere. The preferred bait for the present device is a gel or paste formulation applied to the floor of the inner compartment of the bait station, and having a breachable seal thereon. The preferred transparent bait station cover has a specified light transmission property and is affixed to the base.

In another embodiment, the inner compartment contains a depression formed in the floor of the bait station where a paste-like bait or semi-solid gel-like bait inserted therein, the floor of the base portion of the bait station being sloped upward from the outer edges thereof so that when the depression is formed, it does not extend below the plane of the outer edges of the floor. There is a still a further design, wherein a semi-solid bait may be inserted into a depression formed in the floor of the inner compartment and the transparent bait station cover of specified light transmission can be placed thereover and the inner compartment with a breachable seal.

As an alternative feature of this invention, it may be desirable to coat the floor of the compartment with a contrasting color before inserting and applying or affixing thereto the bait within the bait station. Various colors may be desirable. Those, which are luminous and readily visible in darkened areas, would be most desirable. When at least a part of the cover is transparent, to have a contrasting color beneath the bait, so that it is readily visible in darkened areas. As bait is removed by insects, the contrasting color underneath becomes visible and provides an indication whether insects are using the station and how much bait has been used. The contrast between the bait and the background may be accomplished in a number of ways. A contrasting color may be coated in the inside of the poison area before the bait is placed. The base may be of a transparent material, and a contrasting color backing sheet may be applied to underside of the base. Another method is to form the entire base portion of the station from a plastic, which is of a color that contrasts with the bait.

As an alternative feature of this invention, the station cover and/or base may be composed of various materials, including but not limited to polystyrene, polyethylene, polyethylene terephthalate, polyvinyl chloride, polypropylene, or fiberglass.

As an additional alternative feature of this invention, the station may be sealed as through sonic welding of the cover to the base, heat sealing of the cover to the base, mechanically attaching the cover to the base through threaded components, snap lock fittings, chemically adhering the cover to the base, radio frequency sealing of the cover to the base, hinging the cover to the base, or otherwise encapsulating and sealing the bait in a translucent material and the bait toxicant in the inner compartment is activated by removal of the pull-tab seal to uncover the bait without removing the cover or opening the station.

### BRIEF DESCRIPTION OF THE DRAWINGS

Many advantages of the present invention will be apparent to those of ordinary skill in the art when the specification is read in conjunction with the attached drawings. The invention will now be described with reference to the accompanying drawings wherein like reference numerals are applied to like elements and wherein:

FIG. 1 is a top perspective view of the insect feeding station of the invention with the top cover in place showing the external pull-tab.

FIG. 2 is a top perspective view of an embodiment of FIG. 1 with the cover removed.

FIG. 3 is a top view of FIG. 2 with a partial removal of the seal.

FIG. 4 is a top view of FIG. 2 showing removal of the seal member and exposure of the bait thereunder.

FIG. 5 is a top view of FIG. 2 with the seal member removed and remaining in the station.

FIG. 6 is a top plan view of the embodiment of FIG. 1 with the top cover removed.

FIG. 7 is a side elevation of the embodiment of FIG. 1

FIG. 8 shows a cross-section taken along the lines 8-8 of FIG. 1.

FIG. 9 is a cross sectional view of a unit similar to FIG. 4 taken along lines 9-9 of FIG. 4 with the top cover in place.

FIG. 10 is a top view of a seal member with pull-tab extension and tear drop-shaped, perforated tear end area.

FIG. 11 is a top view of a seal member with pull-tab extension and no perforation.

FIG. 12 is a top perspective view of FIG. 1 with the cover removed and a full seal member is partially removed.

FIG. 13 is a top view of a seal member and with pull-tab extension and central parallel perforated pull back area of FIG. 14.

FIG. 14 is a top perspective view of FIG. 1 with the cover removed and a full seal member in partial removal with a central perforated pull back area of FIG. 13.

FIG. 15 is a top perspective view of the insect feeding station of the invention showing another embodiment of the external pull-tab.

FIG. 16 is a top perspective view of the embodiment of FIG. 15 with top cover removed and full pull back tab unit in place.

FIG. 17 is a top perspective view of FIG. 16 with a partial removal of the removable seal member.

FIG. 18 is a top plan view of a plurality of insect feeding stations made from a single sheet of plastic material.

FIG. 19 is a top perspective view of an alternative embodiment of the insect feeding station of this invention with the cover of FIG. 21 in place.

FIG. 20 is a top plan view of the embodiment of FIG. 19 with the cover removed.

FIG. 21 is a bottom perspective view of a cover of the embodiment of FIG. 19 showing that the guide walls extend from the top.

### DETAILED DESCRIPTION OF THE PREFERRED EMBODIMENTS

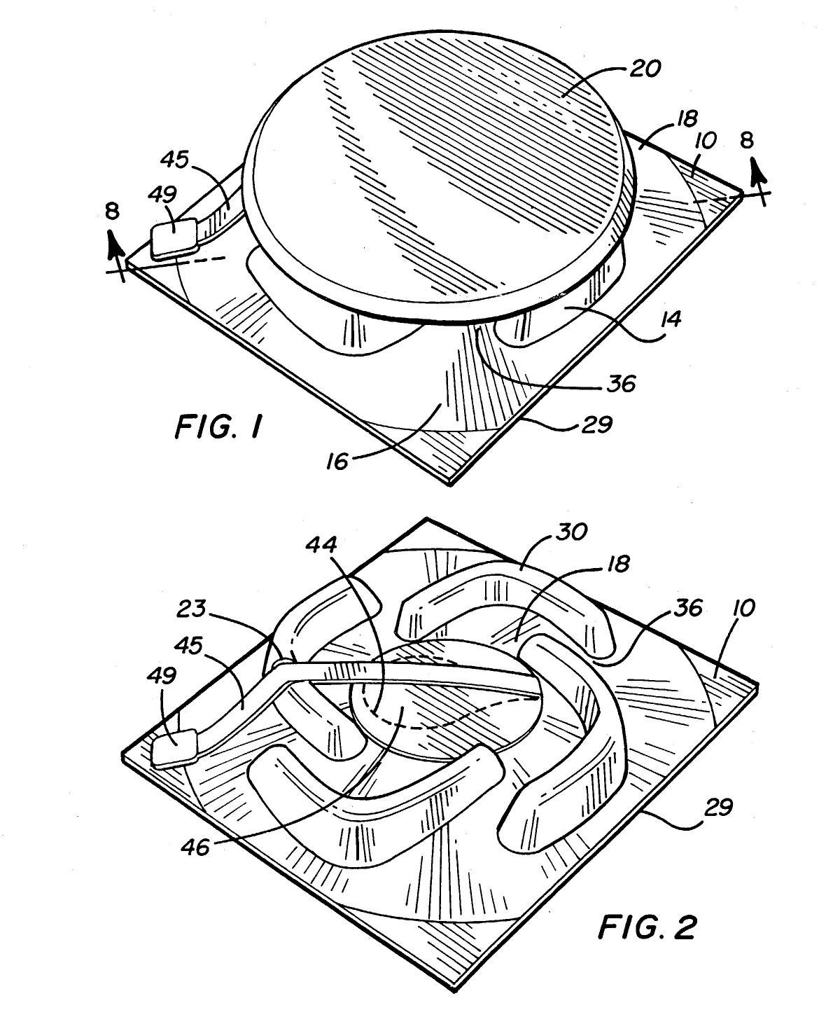

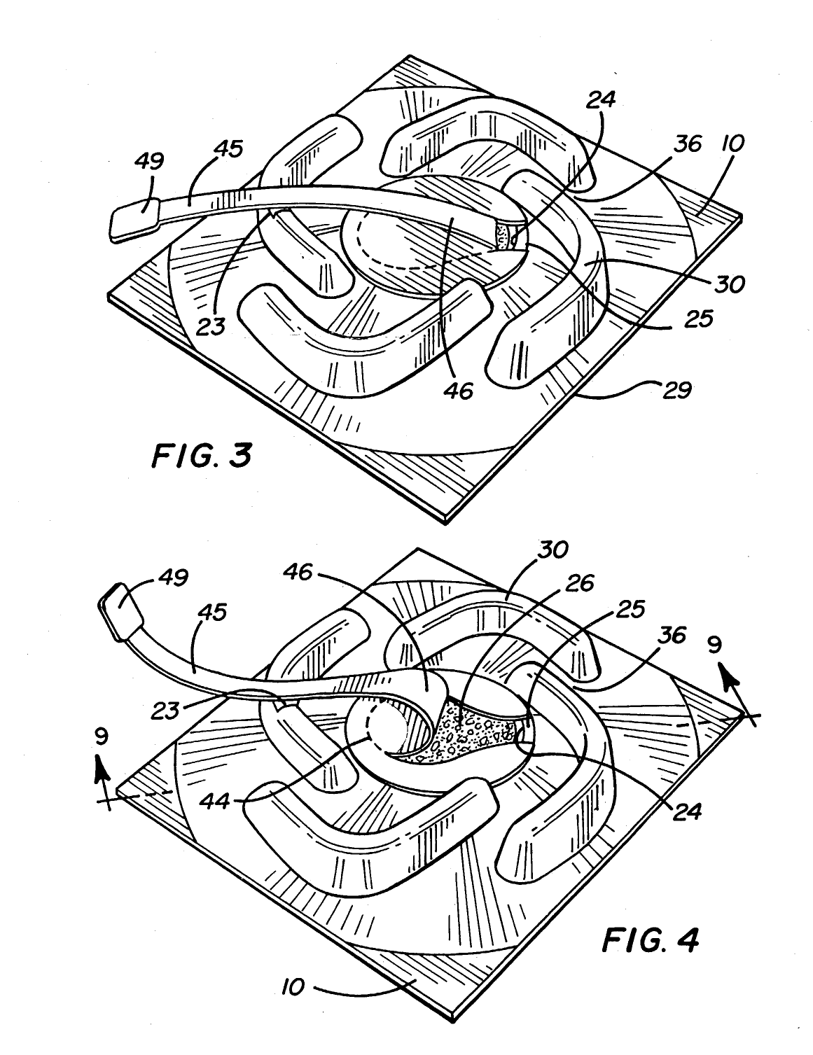

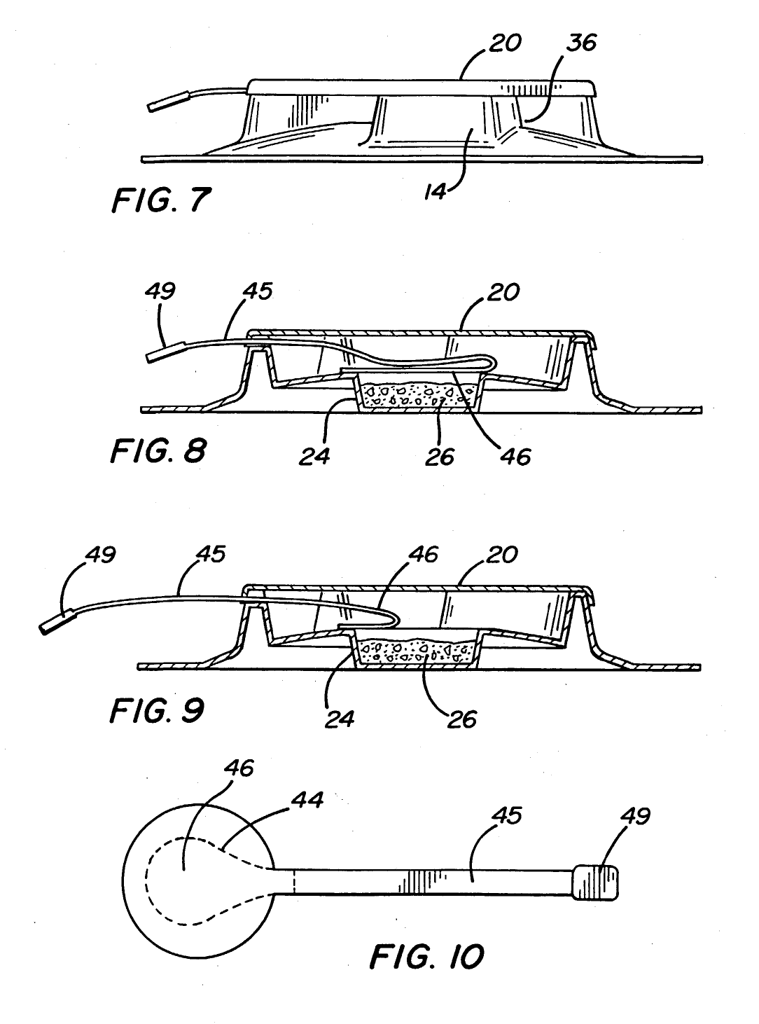

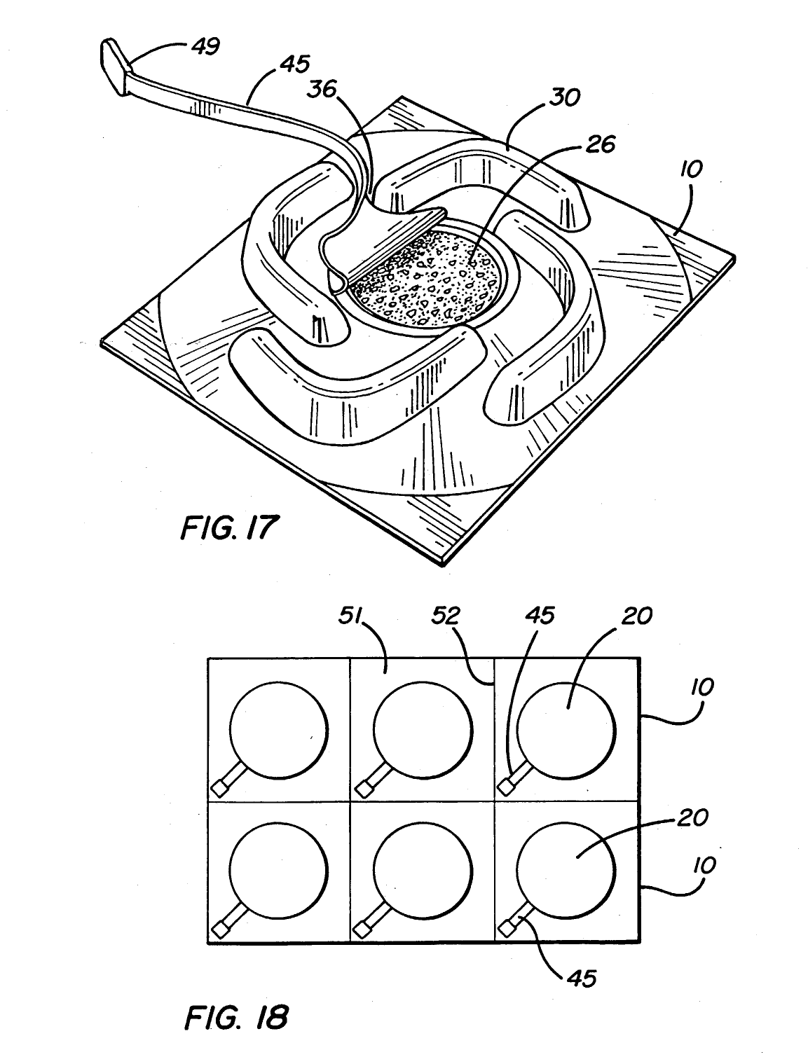

Referring to FIGS. 1 through 21 the insect feeding station of the present invention comprises a base portion 10 and cover 20, with openings 36, a floor 18, and an inner compartment 24 to receive bait toxicant 26. The base portion 10 is formed from a suitable plastic, and may be a transparent plastic, but need not be transparent. The base portion 10 has an outer casing wall 14 which is elongated and curved inwardly towards the center poison area 24 to provide a guiding wall. The extended walls 14 form a plurality of openings 36.

The cover 20 extends to the outer ends of the wall 14. Insects entering openings 36 will be guided along walls 14 to the poison 26. The walls 14 have a curvature such that a probe thrust into any opening 36 cannot contact the poison bait at 26. When a part, or all, of cover 20 is transparent, the poison 26 placed over a contrasting color material is readily visible through the cover. FIGS. 2 through 4 illustrates the preferred embodiment of the device of this invention wherein the base 10 is vacuum formed from a flat sheet of plastic to form walls 14. As shown, the floor 18 rises from the periphery of the device so that the inner compartment is formed by a depression 24 as shown in side view, FIGS. 8 and 9. This is advantageous when the poison or bait is a form of a melt or gel, since it can be poured or placed into the depression and the sealing member 48 can be affixed thereover.

Preferably, the sealing member 48 is a teardrop configuration having an extended pull-tab 45 extending outside the bait station cover 20. The sealing area 46 is conformed to the shape and coextensive with the inner compartment 24, thereby covering said compartment. The sealing area 46 contains a perforation 44 to assist in easy removal of all or part of the sealing area 46 when the pull-tab 45 is pulled. The pull-tab extension 45 is placed outside the bait station through a cutout 23 in a nearby outer casing wall. This allows the user to pull the extension exteriorly from the inner compartment and expose the bait toxicant 26. In this manner, the bait toxicant can remain fresh or moist, for example, if it is a gel formulation.

In the embodiment illustrated in FIGS. 1-6, the inner surface of the outer casing wall is curved inwardly to guide insects entering openings 36 towards openings into the inner poison compartment area 24. This is done to prevent an insect from entering at one outer opening 16 and wandering randomly along the inner wall and out the next opening. Cover 20 extends to the periphery of outer casing walls 14 to close the base portion 10 and may also be formed from a sheet of plastic.

As illustrated, the insect feeding station may be flat on a floor or other desired area. Insects may enter the device through opening 16 and are guided by the curved walls 30 to offset openings to reach bait at the inner compartment 24. The exiting insect may leave through the same openings. The consumption of bait may be optionally viewed through the transparent covers and be optionally readily visible due to contrasting background under the bait.

Although insects may easily reach the bait, it will be readily apparent in FIG. 2 that a probe placed in any of the openings and the outer casing wall 14 will not enter the inner compartment where the bait toxicant is located due to the offset opening and curved walls thereof. Thus, the bait is safe from inquisitive children and small animals.

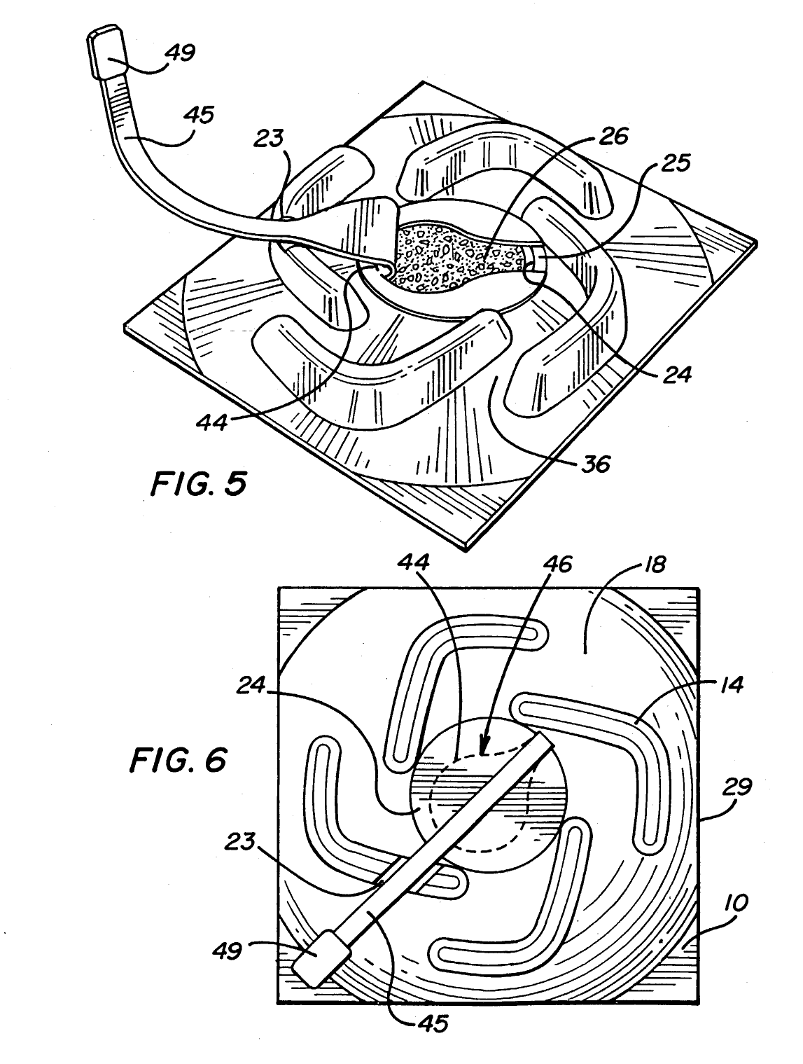

As an alternative embodiment, the bait station of this invention includes a inner compartment 24 for receiving the bait material and having an open upper portion and gradual sloping incline from the station floor, wherein the inner guiding walls and baffle walls of the bait station lead from the exterior peripheral openings to said-inner compartment. As shown in FIGS. 5 and 6, the inner compartment 24 also includes a peripheral lip 25 surrounding the open upper portion. A layer of material 46 having an adhesive backing, preferably of the pressure sensitive type, overlies the peripheral lip 25 thereby sealing the inner compartment 24. The sealing member 46 is comprised of a full sheet plastic/polymeric material, inert metallic foil, paper or laminate thereof and or the like, which is removably adhered to the lip by adhesive or other means, such as heat-sealing or welding. The sealing member 46 is provided with a pull-tab 45 to facilitate removal of all or part of the sealing member 46 from the peripheral lip 25 of the inner compartment 24 and thereby expose the contents of the inner compartment without removing the cover 20 of the station.

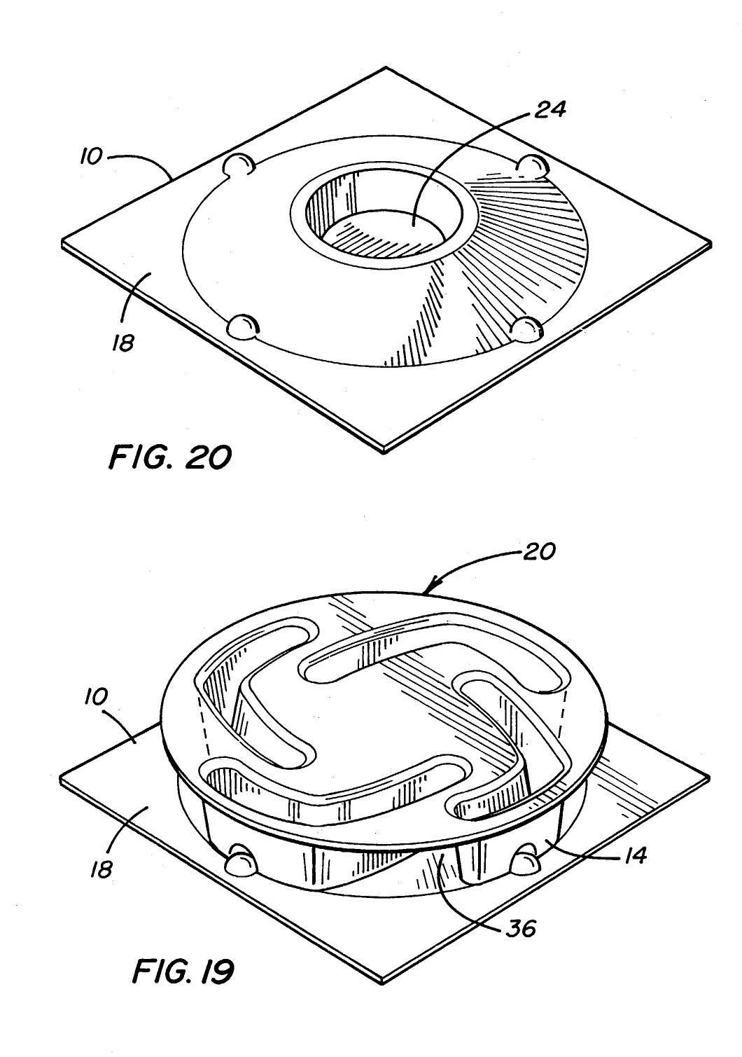

FIG. 18 illustrates the formation of a plurality of insect feeding stations formed on a single sheet of plastic. Sheet 51 is vacuum formed over a suitable mold to form a plurality of base units 10, each of which is then filled with the bait material, removable sealing means with pull-tab placed over the bait in the inner compartment and a station cover to cover the unit. Scored lines 52 are provided on plastic sheet 51 between the various units to facilitate separation of the individual feeding stations. A single backing sheet may be attached to the sheet 51 after vacuum forming. This method of forming insect feeding stations is particularly useful when it is desirable to market a number of devices as a unit, so that the consumer may separate them and use as required or to increase efficiency of manufacture prior to separating.

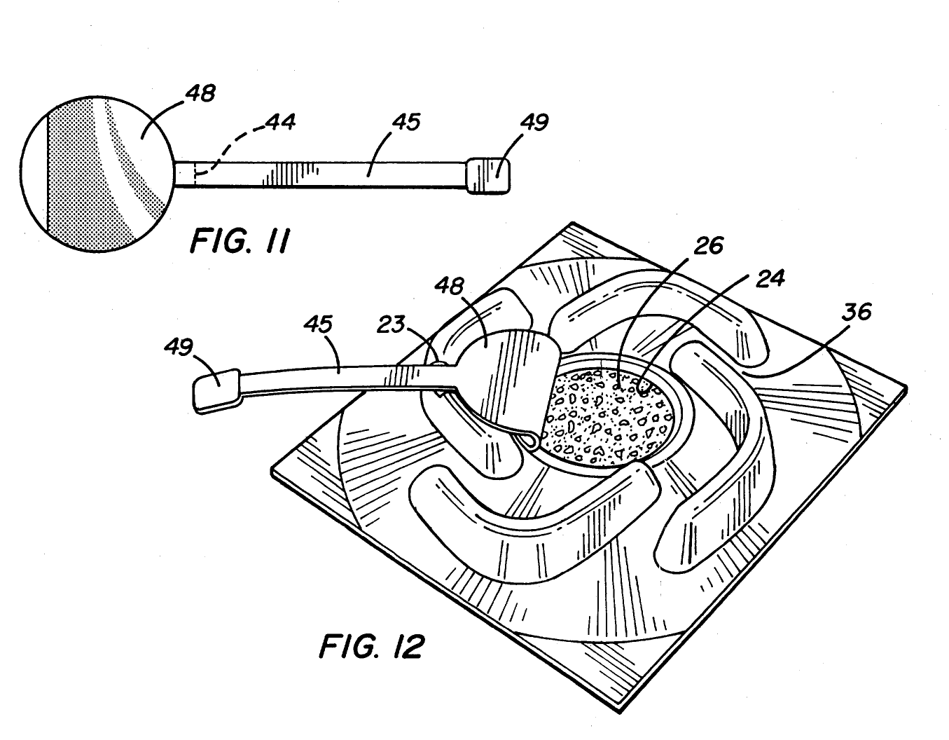

It will be seen that the present invention provides an insect bait toxicant station for administering poison to insects, particularly crawling insects, which has means to guide the insects to the poison and entry baffling system so that children and small animals cannot probe the bait containing compartment and whereby means for controlling the exposure and activation of the poison bait substance in the inner compartment can be controlled by the user of the bait station on demand and whereby gel or moisture-containing insect bait compositions are controlled for freshness or moisture content by having the fully or partially removable sealing means 46 in FIGS. 8 and 9 or 48 in FIGS. 11 and 12 covering the inner compartment 24 without removing the cover.

As illustrated, the insect feeding station may be flat on a floor or other desired area.

Insects may enter the device through openings 36 and are guided by curved walls 30 to offset openings to reach bait 26 in the inner compartment, and may leave through the same openings. The consumption of bait 26 may be viewed through transparent cover 20, if one is used, and optionally be readily visible due to contrasting background under the bait. FIGS. 15, 16 and 17 illustrate an embodiment of the invention, which is essentially similar to the embodiment of FIGS. 1, 2 and 3 in base structure of the device. The outer case walls 30 are elongated and curved inwardly towards the center poison area 24. The segmented extended walls 30 form a plurality of openings 36. A cover 20 extends to the outer ends of walls 30. Insects entering openings 36 will be guided along walls 30 to poison 26. The walls 30 have a curvature such that a probe thrust into any opening 36 cannot contact poison 26. When a part, or all, of cover 20 is transparent, poison 26 is optionally placed over a contrasting color material, as in the embodiment of FIGS. 1, 2 and 3, so that poison 26 is visible through the cover. The inner compartment containing the bait toxicant is covered with a full tear back seal 48 in FIGS. 11 and 12. However, the pull-tab is threaded through an outer case wall opening 36, instead of through the cutout in wall 23 as in FIG. 2.

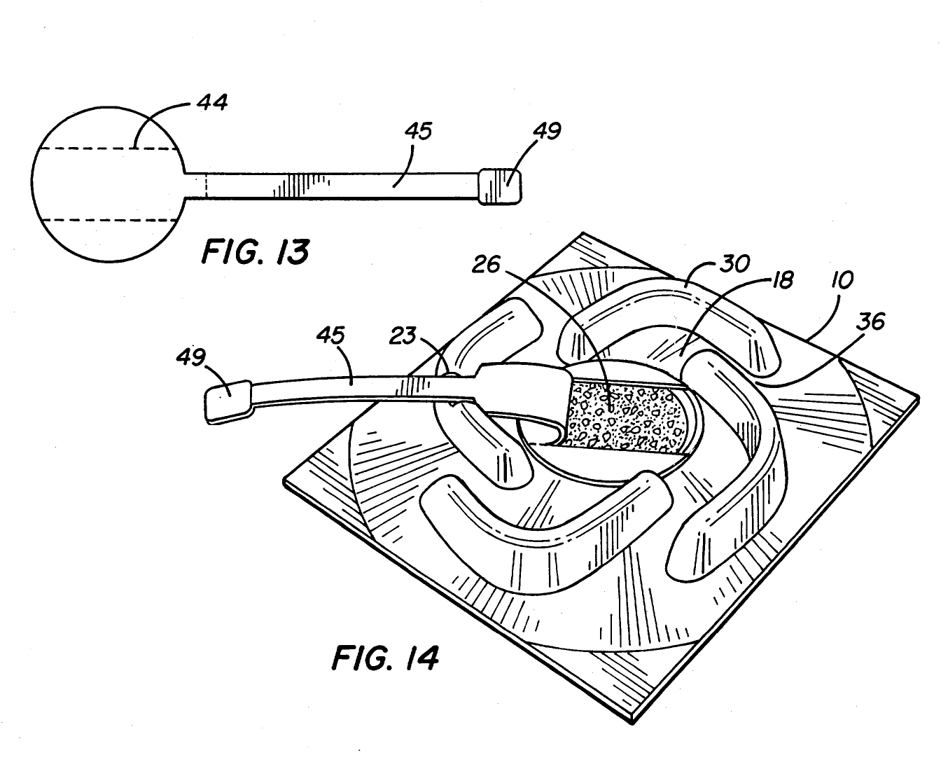

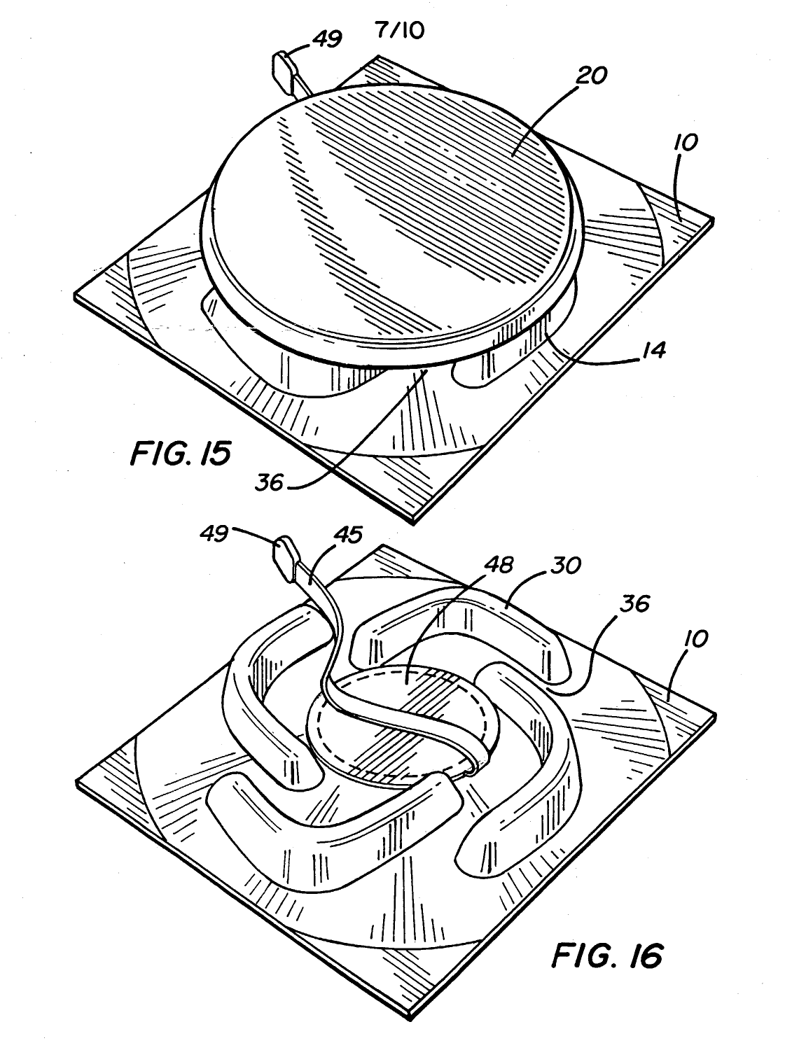

FIGS. 13 and 14 illustrate an alternative embodiment of the device of FIGS. 1, 2, and 3 wherein the pull-tab 45 is connected to a pull back seal with parallel scored lines 44 thereon to guide the tearing and expose most of the bait toxicant thereunder and yet retain some material covered. Base 10 is vacuum formed from a flat sheet of plastic, to form walls 30. As shown, the floor 18 rises from the periphery of the device so that the inner compartment forms a depression to hold the bait toxicant.

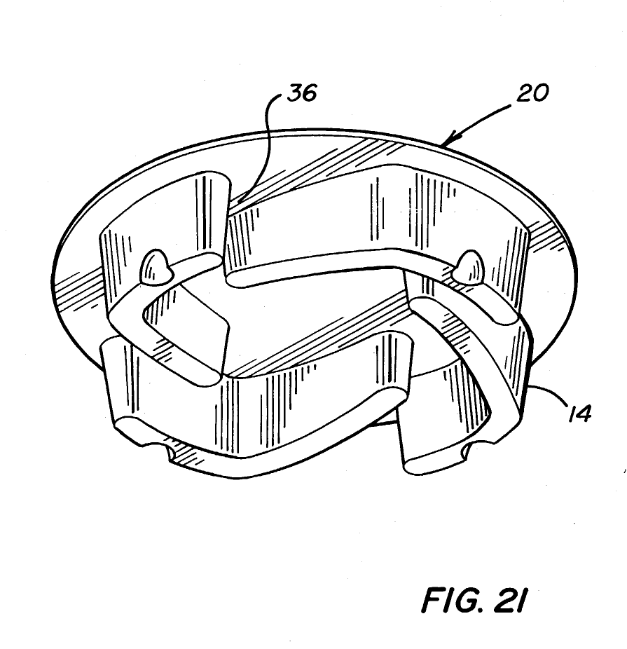

FIG. 19 shows an alternate embodiment of the insect feeding station of FIGS. 1, 2 and 3 with the top cover in place. The top cover as shown in FIG. 21 shows the openings 36 and the guide walls 14 as being integral with the cover 20. FIG. 20 shows the base portion 10 having a floor 18, which rises to form a depression/compartment 24 for receiving the bait toxicant.

Insects attracted to the station to find harborage and food seek the fresh or moist bait in the inner compartment. They enter through access openings 36, and follow the walls 14 to reach the bait-toxicant exposed in the central well area 24. They then feed upon the fresh bait-toxicant, which preferably contains delayed action insecticide, return to their usual hiding place or nest and die. The dead insects, which are now toxic, will then be cannibalized by other insects, extending the kill action of the station to insects, which have not contacted the station directly.

Although other modifications of the bait station described in the present invention will become apparent to those skilled in the art from examination of the above patent specification and drawings, these other variations of the present invention may be made which fall within the scope of the following claims, even though such variations were not specifically discussed above.

Exhibit A

| | | | | | Expiration |
|---|---|---|---|---|---|
| Clorox Case | Country | Patent No. | Application No. | Status | Date |
| 470.05 | U.S. | 4,945,107 | | Issued | Dec. 7, 2007 |
| | New Zealand | 227145 | | Abandoned | |
| | Argentina | 245.567 | | Abandoned | |
| | Spain | 2,063,018 | | Issued | Nov. 21, 2008 |
| | S. Korea | 125383 | | Issued | May 19, 2012 |
| | S. Arabia | 3246 | | Issued | |
| | S. Africa | 88/9134 | | Issued | Dec. 6, 2008 |
| | Norway | | 88/5420 | Abandoned | |
| | Venezuela | 52097 | | Issued | Jun. 30, 2009 |
| | Mexico | 174803 | | Issued | Dec. 5, 2008 |
| | Kuwait | | 101 PA/88 | Abandoned | |
| | Australia | 604387 | 26610/88 | Issued | Dec. 6, 2008 |
| | Italy | 0319757 | | Issued | |
| | France | 0319757 | | Issued | Nov. 21, 2008 |
| | Finland | | 88/5653 | Abandoned | Nov. 21, 2008 |
| | Europe | 0319757 | | Issued | |
| | Brazil | PI8806423-9 | | Issued | Dec. 6, 2008 |
| | Japan | 2083196 (Pub. No. | | Issued | Dec. 6, 2008 |
| | | 121845/95) | | | |
| | Portugal | 89,158 | | Abandoned | |
| | Denmark | | | Abandoned | |
| 470.07 | U.S. | 5,021,237 | | Issued | Nov. 27, 2009 |
| | France | 0430634 | | Issued | Nov. 27, 2010 |
| | Germany | P69012957.2-0 | | Issued | Nov. 27, 2010 |
| | Italy | 0430634 | | Issued | Nov. 27, 2010 |
| | Spain | 2060068 | | Issued | Nov. 27, 2010 |
| | Japan | | 321362/1990 | Pending/Allowed | |
| | S. Korea | 187914 | | Issued | Nov. 26, 2010 |
| | Europe | 0430634 | | Issued | |
| | Mexico | 173157 | | Issued | |
| | England | 0430634 | | Issued | Nov. 27, 2010 |
| | Colombia | | 332449 | Abandoned | |
| | Canada | | 2030706-4 | Pending | Nov. 27, 2010 |
| | Brazil | PI9005978-6 | | Issued | Nov. 26, 2010 |
| | Argentina | 250503 | | Issued | Apr. 18, 2012 |
| | Australia | 626477 | | Issued | Nov. 23, 2010 |
| | South Africa | | | ? | |
| 470.08 | U.S. | | 441796 | Abandoned | |
| | Colombia | | 332450 | Abandoned | |
| | S. Korea | 187991 | | Issued | Jan. 9, 2014 |
| | Spain | 2060067 | | Issued | Nov. 27, 2010 |
| | Mexico | 172524 | | Issued | |
| | Japan | | 321363/1990 | Pending/Allowed | |
| | Italy | 0430633 | | Issued | Nov. 27, 2010 |
| | Germany | P69012753.7-0 | | Issued | Nov. 27, 2010 |
| | France | 0430633 | | Issued | Nov. 27, 2010 |
| | Europe | 0430633 | | Issued | |
| | Canada | 2030708 | | Issued | Nov. 27, 2010 |
| | Brazil | PI 9005979-4 | | Issued | Nov. 26, 2010 |
| | Australia | 628687 | | Issued | Nov. 23, 2010 |
| | Argentina | 252215 | | Issued | Jun. 30, 2013 |
| | England | 0430633 | | Issued | Nov. 27, 2010 |
| 470.08A | U.S. | 5,126,139 | | Issued | Nov. 27, 2009 |
| 470.09 | U.S. | 4,990,514 | | Issued | Feb. 5, 2008 |
| | Brazil | | PI 8801972 | Abandoned | |
| | Venezuela | | 744/88 | Abandoned | |
| | S. Africa | | 88/2954 | Abandoned | |
| | N. Zealand | 224191 | | Abandoned | |
| | Canada | 1329116 | | Abandoned | |
| | Australia | 608597 | | Abandoned | |
| | Argentina | | 310.664 | Abandoned | |
| | Europe | 0289756 | | Abandoned | |
| 470.19 | U.S. | 5,048,225 | | Issued | Jan. 14, 2003 |
| | | | | | (By T.D.) |
| 470.26-1 | Philippines | | 26,833 (Div) | Pending | |
| | Canada | 1103244 | | Expired | |
| 470.27 | S. Africa | 81/1335 | | Issued | |
| | Spain | 499825 | | Issued | Mar. 15, 2002 |
| | Sudan | 2291 | | Abandoned | |
| | Turkey | 21148 | | Expired | |
| | Zambia | 18/81 | | Abandoned | |
| | Brazil | PI81012505-5 | | Expired | |
| | Zimbabwe | 44/81 | | Abandoned | |
| | Venezuela | 43429 | | Expired | |
| | Argentina | 238831 | | Issued | May 31, 2004 |
| | Italy | 1142338 | | Issued | |
| | Greece | 74045 | | Abandoned | |
| | Germany | 31 06 426 | | Issued | |
| | France | 2,476,985 | | Issued | |
| | Canada | 1171087 | | Expired | |
| | Austria | 369951 | | Abandoned | |
| | Japan | 1508496 | | Issued | Feb. 27, 2001 |
| | England | 2070430 | | Issued | |
| 470.28 | U.S. | | 235251 | Abandoned | |
| | Mexico | 151438 | | Expired | |
| | N. Zealand | 200202 | | Issued | Apr. 1, 2002 |
| | S. Africa | 82/2356 | | Issued | Apr. 5, 2002 |
| | Singapore | 2095965 | 8690752-4 | Issued | Apr. 5, 2002 |
| | Venezuela | 45534 | | Expired | |
| | Denmark | 156110 | | Abandoned | |
| | Sweden | | 8202168-4 | Abandoned | |
| | England | 2095965B | | Issued | Apr. 5, 2002 |
| | Canada | 1153267 | | Expired | |
| | Brazil | PI 8201935 | | Issued | |
| | Australia | 553023 | | Issued | Apr. 5, 2002 |
| | Argentina | 232257 | | Expired | |
| | Germany | | P 3212859.2 | Abandoned | |
| 470.31 | U.S. | 4,353,907 | | Expired | |
| | Greece | 77278 | | Abandoned | |
| | S. Africa | 82/0228 | | Expired | |
| | Japan | 1936912 | 356515/91 | Issued | Feb. 9, 2002 |
| | Germany | 32 02 169 | | Issued | |
| 470.31-1 | Japan | 1936912 | | Granted | |
| 470.31-2 | Japan | | 05345766 | Pending | |
| 470.34 | U.S. | | 062,667 | Abandoned | |
| | Europe | | 88107897.6 | Abandoned | |
| | Venezuela | | 8/89 | Pending | |
| | N. Zealand | 224,996 | | Abandoned | |
| | Brazil | | PI 8803106 | Abandoned | |
| | Australia | 609143 | 17685/88 | Issued | Jun. 15, 2008 |
| | Argentina | 247,069 | | Expired (?) | |
| | | (or 216,094?) | | | |
| | Canada | 1333561 | | Issued | Dec. 20, 2011 |
| | S. Africa | 88/4280 | | Abandoned | |
| 470.38 | U.S. | D278842 | | Abandoned | |
| | Australia | 89714 | | Expired | |
| | Japan | 748920 | 51739/82 | Issued | Aug. 10, 2003 |
| 470.38A | Japan | 748920-1 | 23923/85 | Issued | |
| 470.39 | U.S. | 4,563,836 | | Issued | Jan. 14, 2003 |
| 470.41 | U.S. | 4,894,947 | | Issued | Jan. 14, 2003 |
| 470.42 | U.S. | 4,845,103 | | Issued | Jul. 4, 2006 |
| 470.44 | U.S. | | 07/765337 | Abandoned | |
| | U.S./PCT | | US92/07138 | National Phase Entered | |
| | Thailand | 9679 (?) | 016893 | Pending/Issued? | |
| | Mexico | 186638 | | Issued | Sep. 24, 2012 |
| | Romania | | PR-00482 | Abandoned | |
| | Russia | | 94017663.00 | Abandoned | |
| | S. Africa | 92/7303 | | Issued | Sep. 24, 2012 |
| | Malaysia | | PI9201580 | Pending? | |
| | S. Korea | 155399 | | Pending | Jul. 15, 2013 |
| | Singapore | | 9606035-5 | Abandoned | |
| | Taiwan | | 81109182 | Abandoned | |
| | Ukraine | | 95005406 | Abandoned | |
| | Venezuela | 53,985 | | Abandoned | |
| | Spain | 0558706 | | Issued | Aug. 25, 2012 |
| | China | 92112060.5 | 92112060.5 | Allowed | Sep. 24, 2007 |
| | S. Arabia | | 92130259 | Pending | |
| | Argentina | | 323,251 | Pending | |
| | Australia | 673336 | | Issued | Aug. 25, 2012 |
| | Japan | | 506050/93 | Pending | |
| | Canada | | 2119909 | Pending | Aug. 25, 2012 |
| | Czech Rep. | | PV 679-94 | Abandoned | |
| | England | 0558706 | | Issued | Aug. 25, 2012 |
| | Europe | 0558706 | | Issued | |
| | France | 0558706 | | Issued | Aug. 25, 2012 |
| | Germany | 0558706 | | Issued | Aug. 25, 2012 |
| | Hungary | 215950 | | Abandoned | |
| | Indonesia | | P-004744 | Pending | |
| | Italy | 0558706 | | Issued | Aug. 25, 2012 |
| | Brazil | PI9206551-1 | | Issued | Aug. 25, 2012 |
| 470.44B | U.S. | 5,607,682 | | Issued | Mar. 4, 2014 |
| 470.44C | U.S. | 5,676,961 | | Issued | Sep. 12, 2014 |
| 470.48C | U.S. | 5,925,670 | | Issued | Oct. 22, 2012 |
| 470.48E | U.S. | 6,162,825 | | Issued | Oct. 22, 2012 |
| 470.50 | U.S. | 5,271,180 | | Issued | Aug. 11, 2012 |
| | U.S./PCT | | US93/06994 | National Stage Entered | |
| | Europe | | 93917344.9 | Abandoned | |
| | Ireland | | US93/06994 | Abandoned | |
| 470.56 | U.S. | | 08/207777 | Abandoned | |
| | U.S.IPCT | | US95/01544 | National Phase Entered | |
| | Taiwan | | 83107906 | Abandoned | |
| | Singapore | 47846 | | Abandoned | |
| | S. Korea | | 96-704924 | Pending | |
| | S. Arabia | | 95160034 | Pending | |
| | Mexico | | 963941 | Pending | |
| | Thailand | | 025636 | Pending | |
| | Indonesia | | P-950363 | Pending? | |
| | Europe | 0749273 | 0749273 | Pending? | Feb. 8, 2015 |
| | China | | 95191984.9 | Pending | |
| | Canada | | 2182690 | Pending | Feb. 8, 2015 |
| | Brazil | | PI9507000-1 | Abandoned | |
| | Australia | 709549 | | Issued | Feb. 8, 2015 |
| | Argentina | | 331,242 | Abandoned? | |
| | Japan | | 95/523454 | Pending | |
| | Russia | | 96121385 | Pending? | |
| 470.64 | U.S. | D377961 | | Issued | Oct. 15, 2010 (By T.D.) |
| 470.66 | U.S. | D390305 | | Issued | Feb. 3, 2012 |
| 470.68 | U.S. | D374703 | | Issued | Oct. 15, 2010 |
| 470.86 | U.S. | D306895 | | Issued | Mar. 27, 2004 |
| | Venezuela | 3,928 | | Abandoned | |
| | Argentina | 54921 | | Issued | |
| | Brazil | MI4900256 | | Expired | |
| | Canada | 66,091 | | Expired | |
| | Chile | 2196 | | Issued | |
| | Colombia | 325,457 | | Issued | |
| | England | 2,007,922 | | Issued | |
| | France | 904,254 | | Issued | |
| | Japan | 876,832 | | Abandoned? | |
| | Malaysia | ? | | Issued | |
| 470.86A | Colombia | | 300,680 | Abandoned | |
| | Argentina | 56534 | | Issued | |
| | Brazil | | MI5000748 | Abandoned | |
| 470.88 | U.S. | D326890 | | Issued | Mar. 27, 2004 (By T.D.) |
| | Argentina | 56,534 | | Abandoned | |
| | Brazil | MI 5000748 | | Expired? | |
| | Canada | 68,124 | | Expired | |
| | Colombia | | 325457 | Expired | |
| | Japan | 887,101 | | Abandoned | |
| | Venezuela | 4136 | | Abandoned | |
| 470.104 | U.S. | | 08/768006 | Abandoned | |
| | U.S.-PCT | WO 9825454 | US97/23162 | National Stage Entered | |
| | Philippines | | I-58795 | Pending (?) | |
| | Australia | | 57034/98 | Pending | |
| | S. Africa | 97/11145 | | Issued | Dec. 11, 2017 |
| | Chile | | 2715-97 | Pending | |
| | Thailand | | 041247 | Pending | |
| | Taiwan | | 86118849 | Allowed | |
| | Argentina | | P970105871 | Pending | |
| | England | | 97953243.9 | Pending | |
| | Malaysia | | PI9706032 | Pending | |
| 470.104A | U.S. | | 08/986073 | Abandoned | |
| | Argentina | | | Pending | |
| | Taiwan | | 89213051 | Allowed | Dec. 4, 2010 |
| | Thailand | | | Pending | |
| 470.104B | U.S | | 10/000,434 | | |
| 470.106 | U.S. | 5,943,816 | | Issued | Dec. 15, 2017 |
| 470.108 | U.S. | 5,953,854 | | Issued | Dec. 13, 2016 |
| 470.110 | U.S. | 6,117,854 | | Issued | Aug. 20, 2017 |
| | U.S. PCT | | US98/16021 | National Phase Entered | |
| | Thailand | | 045606 | Pending | |
| | Philippines | | 1-1998-02085 | Pending (?) | |
| | Taiwan | | 87113734 | Pending (?) | |
| 470.116 | U.S. | | 09/661,632 | Pending | |
| 470.126 | U.S. | D410724 | | Issued | Jun. 8, 2013 |
| | S. Korea | | 99-382 | Pending | |
| | Australia | 140066 | | Issued | |
| | Japan | | 11(1999)589 | Pending | |
| 470.144 | U.S. | | 09/626,702 | Pending | |
| 700.108 | U.S. | 5,409,368 | | Issued | Jun. 1, 2013 |

We claim:

1. An insect feeding station for administering poison to insects having a cover, an inner compartment containing poison with an interior breachable seal, means for access by said insects to the inner compartment, means for externally breaching said seal without opening said station to allow access to the poison by the insects.

2. The insect feeding station of claim 1 wherein at least a part of said cover is transparent for viewing said poison.

3. The insect feeding station of claim 1 wherein an interior seal is removably affixed over said inner compartment.

4. The insect feeding station of claim 1 wherein said breachable seal is a plastic material, paper stock, inert metallic foil or laminate thereof affixed to the inner compartment with an adhesive.

5. The insect feeding station of claim 1 wherein said interior breachable seal is a pull-tab seal with a pull extension extending beyond the cover.

6. An insect feeding station for administering poison to insects comprising a base portion and a cover, said base portion comprising a floor, an outer wall having a plurality of openings, an inner wall spaced apart from said outer wall and having a plurality of openings, said inner wall openings being offset in a horizontal plane from said outer wall openings, said inner wall forming an inner compartment for said poison, and means on the interior of said outer walls for guiding insects toward said openings in said inner walls, said base portion being formed as a unitary piece from a flat deformable sheet of material and said inner compartment having an interior seal thereover.

7. The insect feeding station of claim 6 wherein at least a part of said cover is transparent for viewing said poison.

8. The insect feeding station of claim 6 wherein said interior seal is breachably affixed to said inner compartment.

9. The insect feeding station of claim 6 wherein an interior seal is removably affixed over said inner compartment.

10. The insect feeding station of claim 6 wherein said interior seal is a plastic material, paper stock, inert metallic foil or laminate thereof affixed to the inner compartment with an adhesive.

11. The insect feeding station of claim 6 wherein said interior seal is a pull-tab seal with a pull extension extending beyond the-cover.

12. An insect feeding station for administering poison to insects comprising a base portion and a cover, said base portion comprising a floor, an outer wall having a plurality of openings, an inner wall spaced apart from said outer wall and having a plurality of openings, said inert wall openings being offset in a horizontal plane from said outer wall openings, said inner wall forming an inert compartment for said poison, and means on the interior of said outer walls for guiding insects toward said openings in said inner walls, said base portion being formed as a unitary piece from a flat deformable sheet of material and said inner compartment having a breachable seal affixed over said inner compartment wherein said interior seal can be breached without opening the station.

13. The insect feeding station of claim 12 wherein at least a part of said cover is transparent for viewing said poison.

14. The insect feeding station of claim 12 wherein an interior seal is removably affixed over said inner compartment.

15. The insect feeding station of claim 12 wherein said breachable seal is a plastic material, paper stock, inert metallic foil or laminate thereof affixed to the inner compartment with an adhesive.

16. The insect feeding station of claim 12 wherein said interior breachable seal is a pull-tab seal with a pull extension extending beyond the cover.

17. An insect feeding station for administering poison to insects comprising a base portion and a cover, said base portion being formed as a unitary piece, said base portion having a center area containing a poison, and a plurality of walls leading from the periphery of said base portion to said center area, said walls being spaced apart to define passageways from said periphery to said center area, each of said walls comprising an outer circumferential portion and an inwardly curved portion defining said passageways such that a direct line into said passageway from the periphery will abut said inner wall portion preventing direct line passage to said center area, and an interior seal is placed over the inner compartment.

18. The insect feeding station of claim 17 wherein at least a part of said cover is transparent for viewing said poison.

19. The insect feeding station of claim 17 wherein an interior seal is removably affixed over said inner compartment.

20. The insects feeding station of claim 17 wherein said interior seal is removably affixed over said inner compartment and including a pull-tab with an extension.

21. The insect feeding station of claim 17 wherein said interior seal is a pull-tab seal with a pull extension extending beyond the cover.

22. The insect feeding station of claim 17 wherein said interior seal is a plastic material, inert metallic foil, paper stock or laminate thereof affixed to the inner compartment with an adhesive.

23. The insect feeding station of claim 17 wherein said poison is a bait mixture of food and poison and is covered with an interior seal having a pull-tab to remove the seal and expose the bait mixture thereunder.

24. An insect feeding station for administering poison to insects comprising a base portion and a cover, said base portion being formed as a unitary piece, said base portion having a center area containing a poison, and a plurality of walls leading from the periphery of said base portion to said center area, said walls being spaced apart to define passageways from said periphery to said center area, each of said walls comprising an outer circumferential portion and an inwardly curved portion defining said passageways such that a direct line into said passageway from the periphery will abut said inner wall portion, preventing direct line passage to said center area, and a breachable interior seal is placed over the inner compartment.

25. The insect feeding station of claim 24 wherein an interior breachable seal is removably affixed over said inner compartment.

26. The insect feeding station of claim 24 wherein said interior breachable seal is a pull-tab seal with a pull extension extending beyond the cover.

27. The insect feeding station of claim 24 wherein at least a part of said cover is transparent for viewing said composition.

28. The insect feeding station of claim 24 wherein said interior seal is a plastic material, inert metallic foil, paper stock or laminate thereof affixed to the inner compartment with an adhesive.
